(19) United States
(12) Patent Application Publication
(10) Pub. No.: US 2011/0247466 A1
(43) Pub. Date: Oct. 13, 2011

(54) APPARATUS FOR SLICING FOOD PRODUCTS

(75) Inventor: Günther Weber, Gross Nemerow (DE)

(73) Assignee: Weber Maschinenbau GmbH Breidenbach, Breidenbach (DE)

(21) Appl. No.: 13/079,103

(22) Filed: Apr. 4, 2011

(30) Foreign Application Priority Data
Apr. 7, 2010 (DE) 102010013892.4

(51) Int. Cl. B26D 7/26; B26D 7/06; B26D 5/02

(52) U.S. Cl. 83/13; 83/401; 83/591

(57) ABSTRACT

An apparatus for slicing food products includes a product feed device, at least one cutting blade which rotates about a blade axis and/or revolves in a planetary motion about a center axis and to which at least one product to be sliced can be fed in a product feed direction and includes a blade holder for the cutting blade. Means are provided for producing a rotary movement of the cutting blade relative to the blade holder and for transforming the relative rotary movement into a linear movement of the cutting blade relative to the blade holder in an adjustment direction.

The present invention relates to an apparatus for slicing food products, in particular to a high-performance slicer, having a product feed device, at least one cutting blade which rotates about a blade axis and/or revolves about a center axis in the manner of a planet and to which at least one product to be sliced can be fed in a product feed direction and having a blade holder for the cutting blade.

Such apparatus are generally known and serve to cut food products such as sausage, meat and cheese into slices at high speed. Typical cutting speeds lie between several 100 to some 1,000 cuts per minute. Modern high-performance slicers differ inter alia in the design of the cutting blade as well as in the manner of the rotary drive for the cutting blade. So-called scythe-like blades or spiral blades rotate about an axis of rotation, here also called a blade axis, wherein this axis of rotation itself does not carry out any additional movement, with this, however, not being compulsory, i.e. alternatively, the axis of rotation can itself carry out an additional movement of whatever kind. Provision is, in contrast, made with slicers having circular blades to allow the rotating circular blade additionally to revolve in a planetary motion about a further axis (here also called a center axis) spaced apart from the axis of rotation. Which blade type or which type of drive is to be preferred depends on the respective application. It can generally be stated that higher cutting speeds can be achieved with only rotating scythe-like blades, whereas rotating circular blades and circular blades additionally revolving in a planetary motion can be used more universally without compromises in the cutting quality.

The above-mentioned high cutting speeds make it necessary—and this applies independently of the type of blade and of the type of drive—that, with a portion-wise slicing of products, so-called blank cuts are carried out in which the blade continues to move, i.e. carries out its cutting movement, but does not cut into the product in so doing, but rather cuts into space so that temporarily no slices are cut off from the product and these, cutting breaks can be used to transport away a portion formed with the previously cut off slices, for example a slice stack or slices arranged overlapping, for example. The time elapsing between two slices cut off after one another is not sufficient for a proper transporting away of the slice portions from a specific cutting performance or cutting speed onward. The length of these “cutting breaks” and the number of blank cuts per “cutting break” are dependent on the respective application.

A problem known in practice in connection with the carrying out of blank cuts is that it is not sufficient in most cases simply to stop the feed of the product temporarily to prevent the cutting off of slices. With products having a soft consistency, it namely regularly occurs that after the stopping of the product feed, relaxation effects come into force, whereby the front product end moves beyond the cutting plane and thus enters into the active zone of the cutting blade. The consequence is an unwanted cutting off of so-called product snippets or product scraps. Apart from this, such a scrap formation always necessarily occurs independently of the product consistency whenever the products are continuously supplied during the slicing operation, i.e. even with products of a solid consistency in which therefore the above-mentioned relaxation effects do not occur, there is scrap formation with a continuous product feed.

The above-described phenomena are sufficiently known to the skilled person so that they will not be looked at in more detail.

Measures are already known from the prior art which serve to avoid scrap formation on the carrying out of blank cuts. Reference is made for this purpose, for example to EP 0 289 765 A1, DE 42 14 264 A1, EP 1 046 476 A2, DE 101 147 348 A1, DE 154 952, DE 10 2006 043 697 A1 and DE 103 33 661 A1.

It has accordingly already been proposed not only to interrupt the product feed for the carrying out of blank cuts, but additionally to retract the product—if necessary together with the product support. This approach in particular reaches its limits when the cutting speeds and/or the masses to be moved in this process become too large since it can then no longer be ensured that the front product end can be retracted sufficiently fast. It has furthermore already been proposed as an alternative to the retraction of the product to move the cutting blade away from the front product end. Both solution approaches have the consequence that a sufficiently large spacing is established between the front product end and the cutting blade which reliably prevents scrap formation. The required blade stroke only amounts to some millimeters; however, it must take place in a very short time in the order of some hundredths of seconds. The possibility of a blade adjustment can also be utilized for further additional functions, e.g. for the setting of the cutting gap or for blank cuts within the framework of a vertical adjustment or an adjustment of the dipping depth of the cutting blade which in particular takes place with respect to the product or products to be sliced or with respect to the product support, which will be looked at in more detail in the following.

The prior art proposes various possibilities of establishing the desired spacing between the blade and product by a transposition of the blade.

One possibility, which is described, for example, in DE 101 47 348 A1, comprises only moving the rotating blade holder to which the blade is replaceably attached and which is also called a blade mount, blade shaft or rotor, and indeed relative to the other components of the so-called blade head which in particular includes, in addition to the mentioned blade holder, a rotary bearing for the rotational movement of the blade or of the blade holder as well as a base part with which the blade head and thus the blade holder is fastened to a rack or frame of the slicer. This fastening can take place, for example, at or in a so-called cutting head housing to which or in which not only the blade head together with the blade is attached, but also the drive motor for the rotary blade drive cooperating with the blade head e.g. via a drive belt

It is also possible to displace the blade head as a whole so that a relative movement between the blade holder and the rotary bearing of the blade is not required. Such a solution is shown, for example in DE 10 2006 043 697 A1.

It is furthermore possible to move the whole cutting head housing together with the blade head and the rotary drive. Solutions of this kind are described, for example, in EP 1 046 476 A2.

These solution approaches explained above do not only differ with respect to the size of the mass to be moved, but also with respect to the construction effort as well as with respect to the applicability for different blade kinds or drive kinds. A movement of only the blade holder, for example, admittedly has the advantage of a relatively small mass to be moved, but does mean a relatively high construction effort since with the blade an object has to be displaced along an axis or moved in a different manner, said object simultaneously rotating at a high speed, e.g. about precisely the named axis. Problems in connection with the journalling of the blade or of the blade holder have to be solved for this purpose. Whereas the above-mentioned scythe-like blades or spiral blades only rotate about one axis, but this axis does not additionally carry out a revolutionary movement, concepts for the adjustment of the blade can be realized with a justifiable effort despite the mentioned journalling problems. This is different with slicers having rotating circular blades which simultaneously revolves in the manner of a planet since there is the problem here of effecting a transposition of only the blade or of the blade holder with a justifiable construction effort.

Independently of the construction problems with respect to the journalling of the blade or of the blade holder, in the known solution approaches, the achievable adjustment speed can be too low due to the masses to be moved in order to carry out blank cuts without quality losses at high cutting speeds. The drives to be provided for the adjustment are moreover often expensive and take up an undesirably large amount of construction space.

It is therefore the object of the invention with a cutting apparatus of the above-named kind to enable a reliable knife movement for providing additional functions in a simple and space-saving manner.

This object is satisfied by an apparatus having the features of claim 1 as well as by a method having the features of claim 18.

In accordance with the invention, means are provided for producing a rotary movement and/or a revolutionary movement of the cutting blade relative to the blade holder and for transforming the relative rotary movement and/or revolutionary movement into a linear movement of the cutting blade relative to the blade holder in an adjustment direction.

The cutting blade is therefore not—as is customary in the technical area—fixedly connected to the blade holder, but there is rather a relative movability between the cutting blade and the blade holder in a specific manner. Apart from this relative linear movability in an adjustment direction, the cutting blade is additionally rotatable with respect to the blade holder, which represents a turning away from the principle used up to now in accordance with the prior art of a rigid drive-effective coupling of the cutting blade and the blade holder.—The relative turning (relative rotation and/or relative revolution) which is brought about between the cutting blade and the blade holder can be transformed into a linear relative movement and can thus be used for the desired adjustment of the cutting blade in the adjustment direction. The adjustment force and the adjustment speed can easily be adapted with a given relative turning by a selection and design of the transformation means. The cutting blade can thus be moved away from the product at times during the ongoing cutting operation by a production, as required, of a relative turning in order thus to carry out additional functions such as blank cuts. The adjustment of the blade can take place particularly fast with an embodiment of the cutting apparatus in accordance with the invention since the blade holder and/or the blade head do not also have to be moved for the adjustment and the mass to be accelerated is thus reduced.

The term “blade holder” is generally to be interpreted widely here. It is a case of a component or of an assembly to which the cutting blade is directly or indirectly held in a manner of any kind and relative to which the rotary and/or revolutionary movement of the cutting blade is produced when an adjustment movement of the cutting blade in the adjustment direction should be obtained.

The term “cutting blade” does not necessarily have to be understood as a single-piece whole here, i.e. it is possible in accordance with the invention, but not compulsory, that only a single component is adjusted with the cutting blade. The cutting blade can be fixedly or releasably connected, e.g. screwed, to a separate component, for example to a socket, which moves together with the cutting blade and serves, for example due to a corresponding configuration, to improve the guidance of the cutting blade. Such an arrangement of cutting blade and separate component should also be considered a “cutting blade” in the sense of the invention.

Advantageous embodiments of the invention are also set forth in the dependent claims, in the description and in the drawing.

The blade holder is preferably in a fixed position viewed in an adjustment direction. The blade holder can in particular be in a fixed position relative to a base frame of the apparatus viewed in an adjustment direction, e.g. relative to a slicer rack or to a slicer frame. Apart from the adjustment direction, the blade holder can naturally be movable, for example in accordance with a rotating and/or revolving drive of the cutting blade or in accordance with other setting or adjustment movements of the associated blade head or blade edge head. In such an embodiment, no separate adjustment apparatus has to be provided for the blade holder.

The adjustment direction preferably extends parallel to the blade axis and particularly preferably coincides with it, whereby a particularly simple construction is made possible.

In accordance with an embodiment, a screw connection is provided between the cutting blade and the blade holder for transforming the relative movement into the linear adjustment movement. A screw connection allows a simple, reliable and inexpensive transformation of a rotary movement and/or revolutionary movement into a linear movement. Alternatively, a compulsory guide could also be provided for transforming the movement, e.g. a cam guide.

In accordance with an embodiment, the blade holder and/or the cutting blade can be accelerated or decelerated for producing the relative movement. It must be pointed out in this connection that within the framework of the invention only a relative movement is important. I.e. in practice, the cutting blade could e.g. also be braked, which is equivalent to an acceleration of the blade holder, or accelerated, which is equivalent to a braking of the blade holder. It must be taken into account in this respect that the product to be sliced can have a decelerating effect on the rotary movement and/or revolutionary movement of the cutting blade during the cutting operation due to its interaction with the cutting blade. This may not result in an adjustment movement of the cutting blade. Optionally, the adjustment concept must be designed suitably or suitable means have to be provided to ensure that unwanted adjustment movements of the cutting blade do not occur.

A control device can be provided which is configured to effect a change in the rotary speed and/or revolutionary speed of the blade holder with respect to the rotary speed and/or revolutionary speed of the cutting blade as required during cutting operation to carry out at least one additional function. Alternatively or additionally, the control device can conversely be configured to effect a change in the rotary speed and/or revolutionary speed of the cutting blade with respect to the rotary speed and/or revolutionary speed of the blade holder as required during a cutting operation to carry out at least one additional function. The control device can for this purpose control suitable acceleration and declaration devices which have an effect on the blade holder and/or on the cutting blade.

The control device can be configured to change the rotary speed and/or revolutionary speed of the blade holder by controlling a rotary drive and/or to change the rotary and/or revolutionary speed of the cutting blade by influencing the cutting blade. This permits a particularly simple and inexpensive construction since in particular no separate acceleration or deceleration apparatus are required when the provided rotary drive is used for the blade holder. In a simple case, the rotary drive for the blade holder is e.g. temporarily deactivated or otherwise slowed down to carry out an additional function in that e.g. an electric motor of the rotary drive has no current supplied at times. It is also possible actively to limit the rotary drive, i.e. only to let it run more slowly without completely switching off the rotary drive. To move the cutting blade back, the rotary drive is then again operated as originally.

The cutting blade can in particular be adjustable between a first end position and a second end position. The spacing between the two end positions then presets the maximum adjustment stroke. Abutments for the cutting blade can be provided at the blade holder to fix the end positions. Such abutments can also serve for the securing of the movable cutting blade to the blade holder. The adjustment stroke can be adapted to different applications by abutment elements which are replaceable or are in turn adjustable.

In accordance with a further embodiment, a threaded section is provided at the blade holder which cooperates with a threaded section of the cutting blade. The pitch of the threads can be adapted to the respective application. A thread with a relatively large pitch is preferably used to achieve an adjustment speed which is as high as possible.

The threaded section at the blade side can be provided at a leadthrough of the cutting blade. The threaded section at the holder side can be provided at a shaft section of the blade holder driven in a rotating manner. It is generally also conceivable to provide the cutting blade with a shaft stub at which a thread is formed and which cooperates with a corresponding nut or with a corresponding threaded section at the blade holder.

In accordance with an embodiment, a coupling between the cutting blade and the blade holder is configured such that the cutting blade endeavors to move against the product feed direction with at least one component on a difference in a rotary speed and/or revolutionary speed in favor of the blade holder. The cutting blade in this embodiment can be urged toward that abutment which corresponds to the end position suitable for cutting during the normal cutting operation due to its inertia, i.e. the cutting blade automatically adopts the correct base position or cutting position.

In accordance with a further embodiment of the invention, the blade holder is a component of a blade head which is in a fixed position viewed in the adjustment direction. Since the blade head is in a fixed position, a corresponding adjustment device for the blade head can be saved.

The blade head can be configured as a head of a scythe-like blade for a scythe-like blade rotating about the blade axis. It is also possible that the blade head is configured as a circular blade head for a circular blade rotating about the blade axis and revolving about the center axis in a planetary motion. In the case of a circular blade head, the relative movement between the cutting blade and the blade holder can relate to the blade axis and/or to the center axis. If, for example, the planetary revolution of the cutting blade is realized by an eccentric arm through which at the one end the center axis extends about which the eccentric arm itself is rotationally driven and the blade axis about which the cutting blade rotates extends at the other end, carrying the cutting blade, the production of the relative movement can then take place either by suitable means at the end of the eccentric arm carrying the cutting blade, that is relate to the blade axis so that the cutting blade is moved in the adjustment direction relative to the eccentric arm which is in fixed position in the adjustment direction. Alternatively or additionally, a relative movement can take place between the cutting blade and the eccentric arm, on the one hand, and a blade holder cooperating with the eccentric arm, on the other hand, that is can relate to the center axis, so that the eccentric arm and the cutting blade move together in the adjustment direction relative to this blade holder. Depending on the specific design, the blade holder can therefore include different components; in the aforesaid examples, the eccentric arm can, when it is in a fixed position in the adjustment direction, be considered as a blade holder, as a component of the blade holder or only as a carrier of a blade holder of any kind, whereas the eccentric arm, when it moves in the adjustment direction with the cutting blade, cannot be considered as belonging to the blade holder.

The blade head can furthermore have at least one rotary drive associated with it which is in particular arranged together with the blade head at or in a cutting blade housing fixed to the rack. The rotary drive also does not necessarily have to be moved in accordance with the invention to adjust the cutting blade. If it is a case of a circular blade head, a single common drive can be provided for the rotation of the cutting blade, on the one hand, and for the revolution of the cutting blade, i.e. for the rotation about the center axis, on the other hand. It is, however, also possible to provide a distinct and/or separate drive, in particular mutually independent drives, for each of these movements.

In accordance with a further embodiment, the cutting blade is movable in the adjustment direction such that there is a spacing change between the cutting blade and a reference plane which extends parallel to a cutting plane defined by the blade edge of the cutting blade located in a cutting position. That plane is e.g. to be understood as the reference plane in which the front end of the product to be sliced, that is the instantaneous cutting surface of the product, at least approximately lies during the cutting operation. The adjustment movement of the cutting blade provides a sufficiently large spacing between the cutting plane always defined by the blade edge of the cutting blade and the front product end, whereby scrap formation is prevented. The reference plane can also coincide with that plane in which the cutting plane lies when the cutting blade is in the cutting position. Even if the cutting blade is not located in the cutting position, that is between the start and end of the adjustment procedure, the reference plane can extend parallel to the cutting plane. This depends on the specific manner of the adjustment movement of the cutting blade.

The cutting blade can in particular be movable in the adjustment direction to carry out at least one additional function, in particular to carry out blank cuts and/or to set the cutting gap.

The invention also relates to a method for slicing food products, wherein at least one product is fed by means of a product feed to a cutting blade for which a blade holder is provided which is driven by means of a rotary drive, wherein the blade holder is either accelerated or decelerated for adjusting the cutting blade relative to the blade holder in an adjustment direction extending parallel to the rotary axis of the blade holder in order to produce a rotary movement and/or revolutionary movement and from this a linear movement of the cutting blade relative to the blade holder.

The invention will be described in the following by way of example with reference to the drawing.

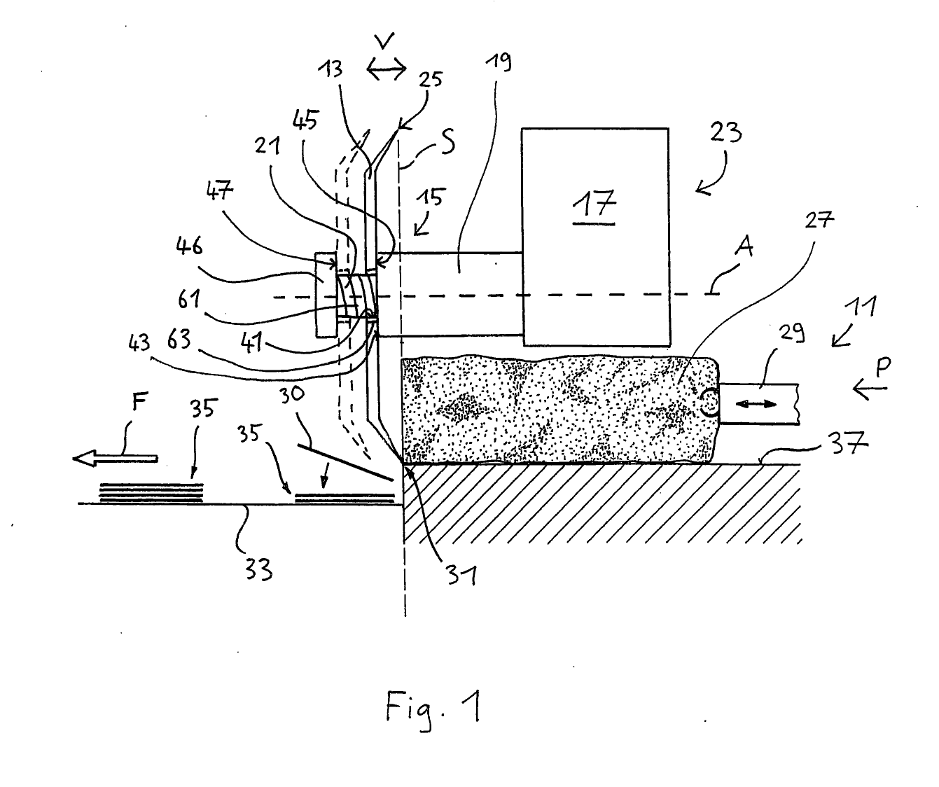

FIG. 1 shows a simplified representation of an apparatus in accordance with the invention for slicing food products.

In accordance with FIG. 1, a high-performance slicer includes a product feed 11, a cutting blade 13 as well as a blade holder 15 for the cutting blade 13. The cutting blade 13 is here configured as a scythe-like blade which rotates about a blade axis A. The blade holder 15 is rotatably supported in a bearing 17 and includes a base section 19 as well as a screw section 21. A rotary drive, not shown, serves to set the blade holder 15 into a rotary movement about the blade axis A by means of a drive belt. The blade holder 15 together with the bearing 17 forms a blade head 23 which is attached together with the rotary drive in a fixed position in a cutting head housing, not shown, of the slicer.

A blade edge 25 of the cutting blade 13 always defines a cutting plane S extending at right angles to the blade axis A independently of the operating state of the cutting blade 13. A product bar 27 is located on a product support 37 of the product feed 11 and rear end holding claws 29 engage at its rear end which are movable by a controlled drive, not shown, in and against a product feed direction P, which is shown by a double arrow in FIG. 1. The product bar 27 is fed along the product feed direction P of the cutting plane S by means of the driven holding claws 29. Instead of a single product bar 27, a plurality of product bars arranged next to one another can also be fed to the cutting plane S together.

During the operation of the high-performance slicer, the rotating cutting blade 13 cuts through the product bar 27 with its blade edge 25 and cuts product slices 30 from said product bar, with it cooperating with a cutting edge 31 forming the end of the product support 37. The coincidence of the cutting plane S with a plane defined by the cutting edge 31 is lost to a simplified representation here. In practice, a small, usually adjustable cutting gap is present between the cutting blade 13 and the cutting edge 31, which does not however, have to be looked at in any more detail here. The feed speed of the product bar 27 and thus the thickness of the product slices 30 is in this respect adjustable by a corresponding control of the driven holding claws 29. The cut-off product slices 30 fall on the rear blade side remote from the product feed 11 onto a support 33 and can be conveyed further or processed further along a conveying direction F and can in particular be fed to an automatic packaging plant (not shown).

It can be seen from FIG. 1 that the slicing of the product bar 27 takes place portion-wise, i.e. the cut-off product slices 30 form portions 35 which are here shown as slice stacks. As soon as a portion 35 is complete, this portion 35 is transported off in the conveying direction F on the support 33. So that sufficient time is available for the transporting away of the finished portions 35, the above-mentioned blank cuts are carried out until the start of the formation of the next portion 35, for which purpose, on the one hand, the product supply also called a product feed—that is here the holding claws 29—is stopped and optionally retracted and, on the other hand, the cutting blade 13 is moved away from the front end of the product bar 27 into the position shown by dashed lines in FIG. 1. By moving the cutting blade 13 into this position spaced apart from the product bar 27, a scrap formation or snippet formation during the carrying out of blank cuts is reliably avoided.

The cutting blade 13 is screwed onto the screw section 21 of the blade holder 15. For this purpose, a leadthrough 41 in the cutting blade 13 has an internal thread 63 which cooperates with a matching external thread 61 at the screw section 21. By turning the cutting blade 13 relative to the blade holder 15, the cutting blade 13 can thus be adjusted in a linear fashion into and against an adjustment direction V on the screw section 21. A nose 43 which forms a rear abutment 45 for the movable cutting blade 13 is formed between the screw section 21 and the base section 19 of the blade holder 15. A securing element 46 whose end face facing the cutting blade 13 forms a front abutment 47 for the cutting blade 13 is attached to the front end of the screw section 21. The securing element 46 can be removed from the screw section 21 in order e.g. to be able to carry out a replacement of the cutting blade 13—which can be easily screwed off.

The cutting blade 13 is screwed onto the screw section 31 up to the rear abutment 45 and the securing element 46 is installed before the slicer is put into operation. During the normal cutting operation, the blade holder 15 is set into a rotary movement by the rotary drive, wherein the inertia of the cutting blade 13 has the effect that the cutting blade 13 is urged toward the rear abutment 45 due to the screw engagement. As soon as a control device, not shown, of the slicer determines that a blank cut phase should be carried out, it effects a deceleration of the rotating blade holder 15 by a corresponding control of the rotary drive. The cutting blade 13 is thereupon screwed up to the front abutment 47 in the adjustment direction V due to the inertia forces, wherein the blade edge 25 of the cutting edge 13 is removed sufficiently far from the product bar 27 so that scrap formation is prevented. In practice, an adjustment stroke of approximately 3 mm and a rotational angle of the cutting blade 13 with respect to the blade receiver 15 of a maximum of 45° have proved sufficient. These values are, however, inter alia, dependent on the respective application and can generally be preset as desired by a suitable design and control. As soon as the control device determines that the blank cut phase should be ended, it controls the rotary drive such that the blade holder 15 is accelerated. Such an acceleration has the effect that the cutting blade 13 is again screwed back up to the rear abutment 45 on the screw section 11 and thus adopts the base position or normal position provided for cutting.

To adjust the cutting blade 13 for a blank cut operation, no separate drive is thus necessary. The adjustment movement rather takes place only while utilizing the acceleration forces by influencing the rotary drive anyway provided.

It is ensured in this concept that the blade holder 15 rotates at the nominal speed provided therefore during the cutting. The fact that the speed for the blank cut phases or other additional functions is temporarily reduced by decelerating the rotary drive is not problematic since anyway no cutting is carried out in these phases. The invention therefore utilizes the circumstance that the blade holder 15 does not have to rotate at the nominal cutting speed for the additional functions.

It must still be mentioned that it may be necessary to balance the cutting blade 13 itself since it carries out a rotary movement and/or revolutionary movement relative to the blade holder 15 during the adjustment procedure and it may therefore be insufficient if only the total system of cutting blade 13 and blade holder 15 is balanced.

### REFERENCE NUMERAL LIST

11 product feed
13 cutting blade
15 blade holder
17 bearing
19 base section
21 screw section
23 blade head
25 blade edge
27 product bar
29 holding claws
30 product slice
31 cutting edge
33 support
35 portion
37 product support
41 leadthrough
43 nose
45 rear abutment
46 securing element
17 front abutment
61 external thread
63 internal thread
A blade axis
S cutting plane
P product feed direction
F conveying direction
V adjustment direction

1. An apparatus for slicing food products (27), comprising
a product feed (11);
at least one cutting blade (13) which rotates about a blade axis (A) and/or revolves in a planetary motion about a center axis and to which at least one product (27) to be sliced can be fed in a product feed direction (P); and
a blade holder (15) for the cutting blade (13),
wherein
means are provided for producing a rotary movement and/or a revolutionary movement of the cutting blade (13) relative to the blade holder (15) and for transforming the relative rotary movement into a linear movement of the cutting blade (13) relative to the blade holder (15) in an adjustment direction (V).

2. An apparatus in accordance with claim 1, wherein said apparatus is a high-performance slicer.

3. An apparatus in accordance with claim 1,
wherein
a screw connection is provided for transforming the relative rotary movement and/or revolutionary movement into the linear adjustment movement between the cutting blade (13) and the blade holder (15).

4. An apparatus in accordance with claim 1,
wherein
the blade holder (15) and/or the cutting blade (13) can be accelerated and/or decelerated for generating the relative rotary movement and/or revolutionary movement.

5. An apparatus in accordance with claim 1,
wherein
a control device is provided which is configured to effect a change in the rotary speed and/or revolutionary speed of the blade holder (15) with respect to the rotary speed and/or revolutionary speed of the cutting blade (13), or vice versa, during a cutting operation to carry out, as required, at least one additional function.

6. An apparatus in accordance with claim 5,
wherein
the control device is configured to change the rotary speed and/or revolutionary speed of the blade holder (15) by control of a rotary drive and/or to change the rotary speed and/or revolutionary speed of the cutting blade (13) by influencing the cutting blade (13).

7. An apparatus in accordance claim 1,
wherein
the cutting blade (13) is adjustable between a first end position and a second end position.

8. An apparatus in accordance with claim 7,
wherein
abutments (45, 45) are provided for the cutting blade (13) to fix the end positions at the blade holder (15).

9. An apparatus in accordance with claim 1,
wherein
a threaded section (61) is provided at the blade holder (15) and cooperates with a threaded section (63) of the cutting blade (13).

10. An apparatus in accordance with claim 9,
wherein
the threaded section (61) at the blade side is provided at a leadthrough (41) of the cutting blade (13).

11. An apparatus in accordance with claim 9,
wherein
the threaded section (63) at the holder side is provided at a rotationally driven shaft section (21) of the blade holder (15).

12. An apparatus in accordance with claim 9,
wherein
a coupling is configured between the cutting blade (13) and the blade holder (15) such that the cutting blade (13) endeavors to move with at least one component against the product feed direction (P) on a difference in a rotary movement and/or revolutionary movement in favor of the blade holder (15).

13. An apparatus in accordance with claim 1,
wherein
the blade holder (15) is a component of a blade head (23) which is in a fixed position viewed in the adjustment direction (V).

14. An apparatus in accordance with claim 1,
wherein
a blade head (23) is configured as a head of a scythe-like blade for a scythe-like blade (13) rotating about the blade axis (A); or wherein a blade head is configured as a circular blade head for a circular blade rotating about the blade axis and revolving in a planetary motion about the center axis.

15. An apparatus in accordance with claim 1,
wherein
at least one rotary drive is associated with a blade head (23).

16. An apparatus in accordance with claim 15,
wherein
the rotary drive is arranged together with the blade head (23) at or in a cutting head housing fixed to the rack.

17. An apparatus in accordance with claim 1,
wherein
the cutting element (13) can be moved away in the adjustment direction (V) such that there is a change in the spacing between the cutting blade (13) and a reference plane which extends parallel to a cutting plane (S) defined by the blade edge (25) of the cutting blade (13) located in a cutting position.

18. An apparatus in accordance with claim 1,
wherein
the cutting blade (13) is movable in the adjustment direction (V) for carrying out at least one additional function for carrying out blank cuts and/or for the cutting gap setting.

19. A method for slicing food products (27) using an apparatus for slicing food products (27) or a high-performance slicer, comprising
a product feed (11);
at least one cutting blade (13) which rotates about a blade axis (A) and/or revolves in a planetary motion about a center axis and to which at least one product (27) to be sliced can be fed in a product feed direction (P); and
a blade holder (15) for the cutting blade (13),
wherein means are provided for producing a rotary movement and/or a revolutionary movement of the cutting blade (13) relative to the blade holder (15) and for transforming the relative rotary movement into a linear movement of the cutting blade (13) relative to the blade holder (15) in an adjustment direction (V;
wherein at least one product (27) is fed by means of a product feed (11) to a cutting blade (13) for which a blade holder (15) driven by means of a rotary drive is provided and;
wherein the blade holder (15) is ether accelerated or decelerated for adjusting the cutting blade (13) relative to the blade holder (15) in an adjustment direction (V) extending parallel to the axis of rotation of the blade holder (15) to produce a rotary movement and/or revolutionary movement and from this a linear movement of the cutting blade (13) relative to the blade holder (15).
